(19) United States
(12) Patent Application Publication
(10) Pub. No.: US 2025/0131543 A1
(43) Pub. Date: Apr. 24, 2025

(54) SYSTEM AND METHOD FOR OBJECT MEASUREMENT

(71) Applicant: MOLDOVA AVIATION SERVICES (2001)LTD., Tel Aviv-Yafo (IL)

(72) Inventors: Felix ROITMAN, Tel Aviv-Yafo (IL); Elad MEIR, Tel Aviv-Yafo (IL)

(21) Appl. No.: 18/681,575

(22) PCT Filed: Nov. 30, 2022
(86) PCT No.: PCT/IL2022/051278

§ 371 Date: Feb. 6, 2024

(30) Foreign Application Priority Data
Dec. 6, 2021 (IL) 288740

(51) Int. Cl. G06T 5/80; G06Q 50/40; G06T 7/11; G06V 10/82

(52) U.S. Cl. CPC G06T 5/80; G06Q 50/40; G06T 7/11; G06V 10/82; G06T 2207/20084; G06T 2207/30112

(57) ABSTRACT

A system for object measurement including one or more user devices having a camera, one or more modules performing one or more tasks, a memory unit for storing, loading, and/or maintain the modules. The user's device further having a processor interpreting and/or executing computer-readable instructions. A communication unit to communicate with at least one communication network and a user interface the system further including a reference object with predetermine known size. The camera takes picture of the reference object and the measurement object. One or more of the modules identifying the referenced object in the picture. One or more of the modules used for identifying the measurement object in the picture. One or more of the modules used for calculating the size of the measured object, utilizing the predetermine known size of the referenced object detection.

### FIELD OF THE INVENTION

The present invention relates to system and method for object measurements, in particular system and method for object measurements of carry-on bags intended to be carry on a cabinet of an airplane.

### BACKGROUND OF THE INVENTION

The check-in process at airports enables passengers to check-in luggage or bags onto a plane and to obtain a boarding pass. When presenting at the check-in counter, a passenger will provide evidence of the right to travel, such as a ticket, visa, or electronic means. Each airline provides facilities for passengers to check-in their luggage. This may be by way of airline-employed staff at check-in counters at airports or through an agency arrangement or by way of a self-service kiosk. The luggage is placed on a conveyor, tagged and weighed. The conveyor then usually feeds the luggage into the main baggage handling system. The luggage goes into the aircraft's cargo hold. The check-in staff then issues each passenger with a boarding pass.

Carry-on bags refer to the type of luggage that passengers are allowed to carry along in the passenger compartment of a vehicle such as but not limited to airplanes cabinets. Passengers are allowed to carry a limited number of smaller bags with them in the passenger compartment, which typically contain valuables and items needed during the journey. There is normally storage space provided for hand luggage, either under seating, or in overhead lockers.

The International Air Transport Association (IATA) sets guidelines for cabin baggage/hand, luggage/carry-on, luggage size. The guidelines are not mandatory, however, and individual airlines can and do vary their requirements. The IATA guideline at one time stated for example that carry-on bags should have a maximum length of 56 cm, width of 45 cm and depth of 25 cm including all handles, side pockets, wheels etc.

The actual size and weight limits of carry-on bags can differ widely in some cases they are dependent on the aircraft model being used; in other cases, it depends on the booking class. Due to the lack of standardization many different specifications were created by the airlines on the maximum permitted carry-on bags restrictions.

If the passenger carry-on exceeds the maximum allowed baggage size, then the airline will probably will not allowed the passenger to carry-on the baggage to the airplane cabinet. This will lead the passenger to check again his baggage and delaying the check-in which is the process whereby people announce their arrival at an airport.

Therefore, there is a need for a system and method for measuring objects that can be carry-on airplane cabinet. Such issues are addressed for example in U.S. Pat. No. 10,885,655 and U.S. Pat. No. 9,518,861.

U.S. Pat. No. 10,885,655 describes systems and methods for object measurement. One embodiment of the invention includes a system including a processor, a memory in communication with the processor, an input device, and an image capture device, wherein the processor obtains image data using the image capture device in response to input received from the input device indicating that image data should be captured, identifies a set of feature points within the obtained image data, completes the obtaining of the image data based on the set of feature points identified and in response to input received from the input device indicating that image data should no longer be captured, generates a model based on the set of feature points, measures the generated model with respect to a reference plane, and provides an indication of the measured size of the generated model.

U.S. Pat. No. 9,518,861 describes a system for controlling and verifying the size and weight of a piece of carry-on luggage. In one embodiment, one or more database servers is configured for selectively storing data related to one or more of the luggage, one or more passengers in possession of the luggage, a transportation vehicle on which the passenger plans to travel, and a transportation hub from which the transportation vehicle is to depart. One or more luggage devices are in selective communication with the one or more database servers and includes a receptacle configured for removable receipt of the luggage the receptacle formed having a bottom, a back wall, and an at least one side wall and at least one verification device integral with the receptacle for determination of at least one of a height, depth, width, weight, and identification information associated with the luggage.

One of the objects of the present invention is to provide a system and method for measuring objects that can be carry-on in an airplane cabinet.

Another object of the present invention is to provide a system and method for applying accurate size measurements of a potential carry-on luggage.

Yet another object of the present invention is to simplify and improve the measurement process and shorten the processing time of the measurement results.

### SUMMARY OF THE INVENTION

The present invention relates to system and method for object measurements, in particular system and method for object measurements of carry-on bags.

In accordance with one aspect of the present invention there is provided a system for object measurement including, one or more user devices having: one or more cameras, one or more modules performing one or more tasks, one or more memory units for storing, loading, and/or maintain the one or more modules. The user device further having one or more processors interpreting and/or executing computer-readable instructions. In the processor access and/or modify and execute the at least one or more modules stored in the memory. The one or more communications units used to communicate with one or more communication networks. The device also includes a user interface. The system further includes one or more reference object with predetermine known size. One or more of the cameras take picture of the one or more reference object and the one or more measurement objects. The one or more modules used for identifying the referenced object. The one or more modules used for identifying the measurement object. The one or more modules used for calculating the size of the measured object utilizing the predetermine known size of the referenced object detection.

In accordance with another aspect of the present invention there is provided a method for object measurement having one or more user devices with one or more cameras, the one or more user devices communicating over a communication network and one or more databases communicating with the user device over the communication network including the steps of placing one or more object references and object measurements aligned to one another. Taking at least one picture of one or more object measurements and the one or more reference objects by the user device camera. Applying a machine learning (ML) algorithm for detecting objects in the one or more one taken pictures. Applying an algorithm to identify the referenced object in the at least one picture. Applying an algorithm to identify the measured object in the at least one picture. Calculating the size of the measured object relative to predetermine known size of one or more referenced object detections. If the size of one or more measured objects is bigger than the size of a predetermine object size one or more measured objects is not confirmed, otherwise one or more measured objects is confirmed.

### BRIEF DESCRIPTION OF THE DRAWINGS

The invention may be understood upon reading of the following detailed description of non-limiting exemplary embodiments thereof, with reference to the following drawings, in which:

FIG. 1 is an interface view that illustrates an approved carry-on bag interface that include an interface element that enables approval of the carry-on bag in accordance with one embodiment of the present invention;

FIG. 2 is an interface view that illustrates a not approval carry-on bag interface that include an interface element that does not enable approval of the carry-on bag in accordance with one embodiment of the present invention;

FIG. 3 is a block diagram of an exemplary implementation of a system for object measurements of carry-on bags in accordance with one embodiment of the present invention;

FIG. 4 is a schematic top view of a camera, a reference object and a measured carry-on bag object;

FIG. 5 is a schematic side view of the camera, the reference object and the measured carry-on bag object;

FIG. 6 is a flow diagram of an exemplary method for measuring objects in accordance with some embodiments of the present invention;

FIG. 7A is an interface view that illustrates a login page of airline-employed staff;

FIG. 7B is an interface view that illustrates options page;

FIGS. 8A-8D are interface views that illustrate pages for managing user/worker in accordance with some embodiments of the present invention;

FIGS. 9A-9C are interface views that illustrate pages for creating new user/worker on one or more databases;

FIGS. 10A-10B are interface views that illustrate pages for updating existing user/worker on one or more databases;

FIGS. 11A-11F are interface views that illustrate workflow interface for user/worker;

FIG. 12 is an interface view that illustrates shift report; and

FIG. 13 is an interface view that illustrates periodic report.

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS OF THE INVENTION

The present invention relates to system and method for object measurements, in particular system and method for object measurements of carry-on bags. Type of users that can be use the system and method of the present invention are for example airlines admin workers, one or more managers/workers of ground airport handling agents, airline-employed staff at check-in counters at airports or through an agency arrangement or by way of a self-service kiosk, airlines subcontract ground handling to airports, handling agents or even to another airline. Ground handling addresses the many service requirements of an airliner between the time it arrives at a terminal gate and the time it departs on its next flight.

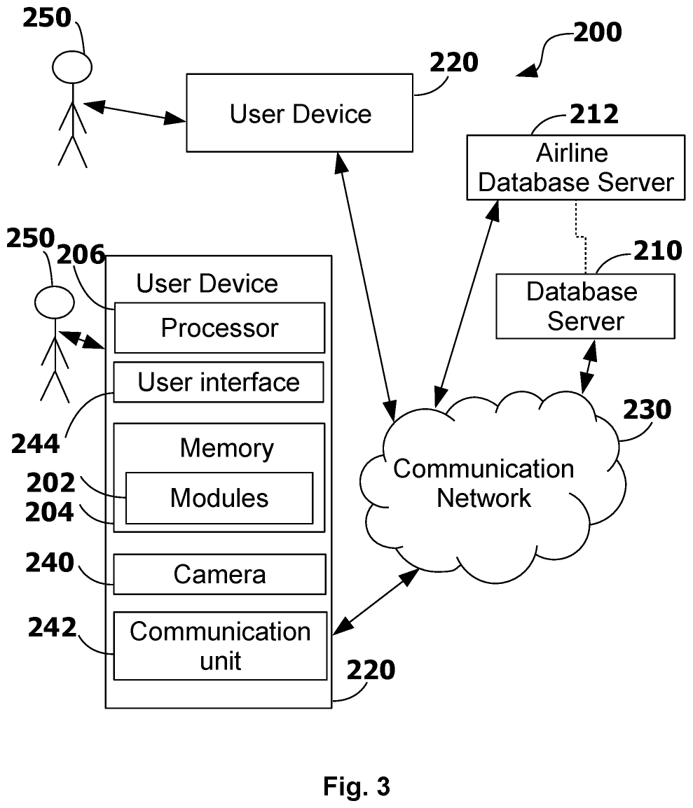

Referring to FIG. 3, the system of the present invention includes one or more databases such as databases 210 and 212 and one or more applications that can be connected to the database. The application can be installed on any web device 220 such as but not limited to smartphones, personal computers, terminals, tablets etc. A user 250 of the application that is authorized to do so, such as for example an admin user, can for example enters in the database 210 of the application of the present invention for example flight schedules data, the user may also enter the carry-on bag dimensions in a particular flight and enters data of standard deviation size of a carry-on bag in a particular flight and according to a particular airplane model.

A user 250 that is authorized to do so such as for example an admin user, may also enter or load the flight(s) data such as but not limited to flight number, date of flight, hour of flight (the application of the invention will automatically compute the opening of the boarding flight according to the flight hour that will be entered or otherwise can be loaded from a data file). The user 250 if authorized to do so, can also enter in the application of the invention the flight data from one destination (country of origin) to another destination (destination country). The user, if authorized to do so, can also enter the dimensions of allowed carry-on bag that can be entered to the airplane cabinet, such as the bag length width and bag depth. The details of airline-employed staff are also entered to the application of the invention such as employ's first and last name, employ's username, and password.

When the airline-employed staff reaches to the check-in counter at the airport, one or more application users, for example, airline-employed staff request access from the application of the system 200 of the invention for allowing to enter data about the potential carry-on bags that will potentially allowed to get into the cabinet of planes regarding to the flights that the employee is assigned to. The handling manager of the employee may approve in the application of the invention the employee's work and the manager can verifies that the employee is indeed assigned to the flights to which he requests access and approved accordingly. The handling manager agent can enter in the database 210 of the application of the invention the allowed handling workers that can enter and view data about the flight passengers and their carry-on bag(s).

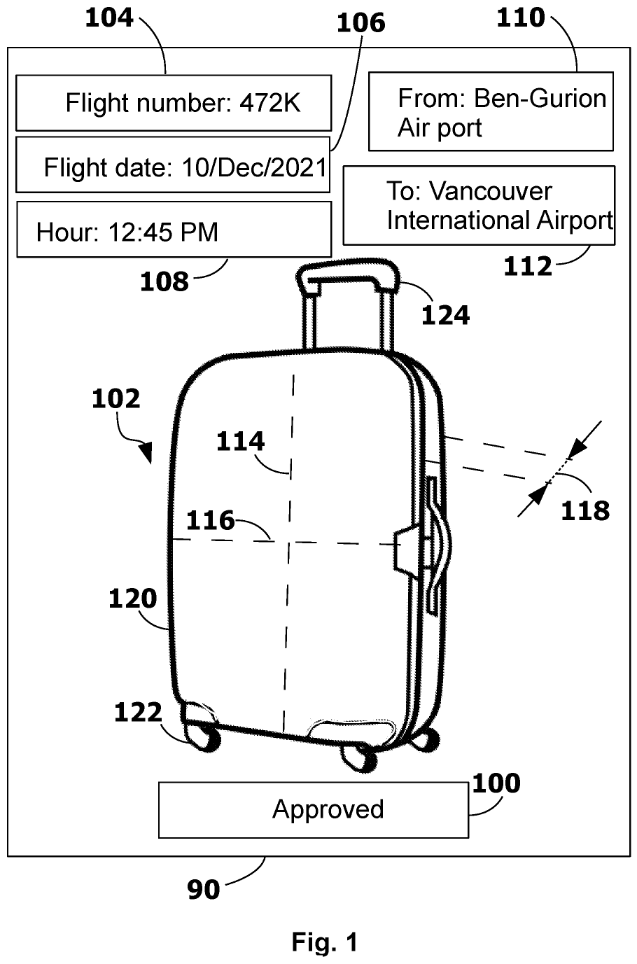

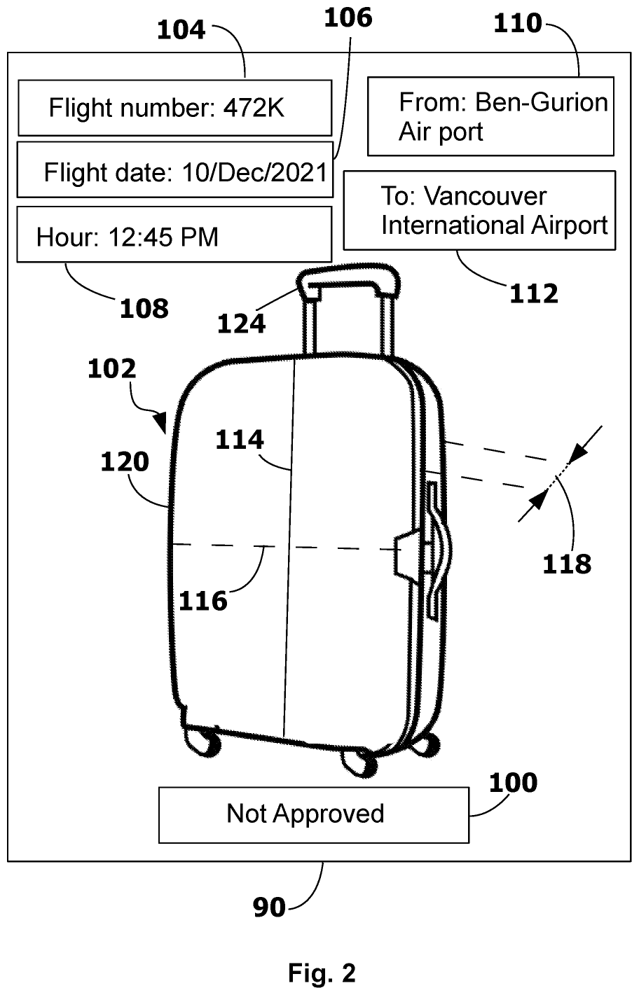

Referring to FIG. 1 and FIG. 2, in accordance with some embodiments of the present invention after the employee is authorized in the application of the invention regarding approval of carry-on bags in certain flight, the employee can take a picture of the carry-on bag of a passenger which can be positioned for example on the conveyor belt at the airlines counter in such a way that the entire size of the carry-on bag can been seen. Then, the taken photo will be stored in the application database 210 for future uses. The application can process the stored picture of the pictured carry-on bag and outputs to the employee on an interface view 100 the status of the carry-on bag whether the bag is allowed to enter the airplane cabinet or not. The application can output on the interface view 100 the picture 102 of the stored carry-on bag and on the top of interface view 100 for example a texture about the flight details such as but not limited to flight number 104, flight date 106, hour of flight 108, from source 110 to destination of flight 112. The processed picture may also include lines that represents the measured length 114, width 116, and depth 118 of the carry-on bag 102. The lines can be in colored in such a way that for example a measured line is colored green (designated by dashed line in FIGS. 1 and 2) these lines designate that the length of the carry-on bag does not exceed the allowed measurement. However, if for example the line is colored red (designated by solid line for example as shown in FIG. 2) it means this line measurement which represent one dimension measurement of the carry-on bag is exceeding the allowed dimension. All the data and the processed data can be stored automatically in one or more databases (which can be also cloud databases) 210 and 212 for future use and analysis. The exemplary carry-on bag that shown in FIGS. 1 and 2 include an interface view page 90 that includes an object of a bag body 120 bag wheels 122 and telescopic bag handle 124.

Referring to FIG. 3 a block diagram of an exemplary system 200 for object measurements and management of carry-on bags on flights in accordance with some embodiments of the present invention is illustrated. As illustrated in this figure, exemplary system 200 may include one or more modules 202 for performing one or more tasks. As further illustrated in FIG. 3, exemplary system 200 may also include one or more memory devices, such as memory 204. Memory 204 generally represents any type or form of volatile or non-volatile storage device or medium capable of storing data and/or computer-readable instructions. In one example, memory 204 may store, load, and/or maintain one or more of modules 202. Examples of memory 204 include, without limitation, Random Access Memory (RAM), Read Only Memory (ROM), flash memory, Hard Disk Drives (HDDs), Solid-State Drives (SSDs), Double Data Rate Synchronous Dynamic Random-Access Memory (DDR SDRAM), optical disk drives, caches, variations or combinations of one or more of the same, or any other suitable storage memory.

As further illustrated in FIG. 3, exemplary system 200 may also include one or more physical processors, such as physical processor 206. Physical processor 206 generally represents any type or form of hardware-implemented processing unit capable of interpreting and/or executing computer-readable instructions. In one example, physical processor 206 may access and/or modify one or more of modules 202 stored in memory 120. Additionally, or alternatively, physical processor 206 may execute one or more of modules 202.

Examples of physical processor 206 may include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As also illustrated in in FIG. 3, exemplary system 200 may also include one or more databases, such as databases 210 and 212. In at least one example, databases 210 and 212 for storing information associated with passengers' carry-on bags measurement approval data and the passenger flights data 142. Databases 210 and 212 may represent portions of a single database or computing device or a plurality of databases or computing devices. In some embodiments, databases 210 and 212 may be a logical container for data and may be implemented in various forms (e.g., a database, a file, a data structure, etc.).

User device such as devices 220 generally represents any type or form of computing device capable of reading and/or executing computer-executable instructions. In at least one embodiment, user device 220 may accept one or more directions from database servers 210 and 212. Examples of user device 220 include, without limitation, servers, desktops, laptops, tablets, cellular phones, (e.g., smartphones), personal digital assistants (PDAs), multimedia players, embedded systems, wearable devices (e.g., smart watches, smart glasses, etc.), gaming consoles, combinations of one or more of the same, or any other suitable mobile computing device.

Communication network 230 generally represents any medium or architecture capable of facilitating communication and/or data transfer between user device 220 and/or data servers 210 and 212. Examples of communication network 230 include, without limitation, an intranet, a wide-area network (WAN), a local area network (LAN), a personal area network (PAN), the Internet, Power Line Communications (PLC), a cellular network (e.g., a Global System for Mobile Communications (GSM) network, a code-division multiple access (CDMA) network, a Long-Term Evolution (LTE) network, etc.), universal serial bus (USB) connections, and the like. Network 230 may facilitate communication or data transfer using wireless or wired connections. In at least one embodiment, network 230 may facilitate communication between user device 220 and servers 210 and 212.

Database servers 210 and 212 generally represents any type or form of computing device capable of reading and/or executing computer-executable instructions and/or hosting executables. Examples of servers 210 and 212 include, without limitation, application servers, storage servers, database servers, web servers, cloud servers, and/or any other suitable computing device configured to run certain software applications and/or provide various application, storage, and/or database services.

In at least one example, user device 220 and servers 210 and 212 may be computing devices programmed with one or more modules. All or a portion of the functionality of the modules may be performed by user device 220, servers 212, 210, and/or any other suitable computing system. As will be described in greater detail below, one or more of modules for example such as modules 202 may, when executed by at least one processor of user device 220, enable several functions that will be described later in more detail. As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally, or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

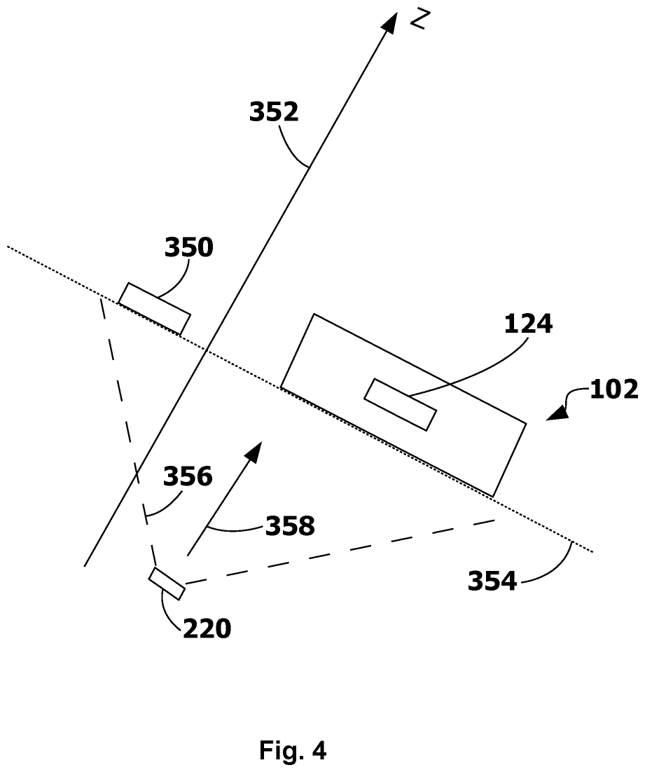

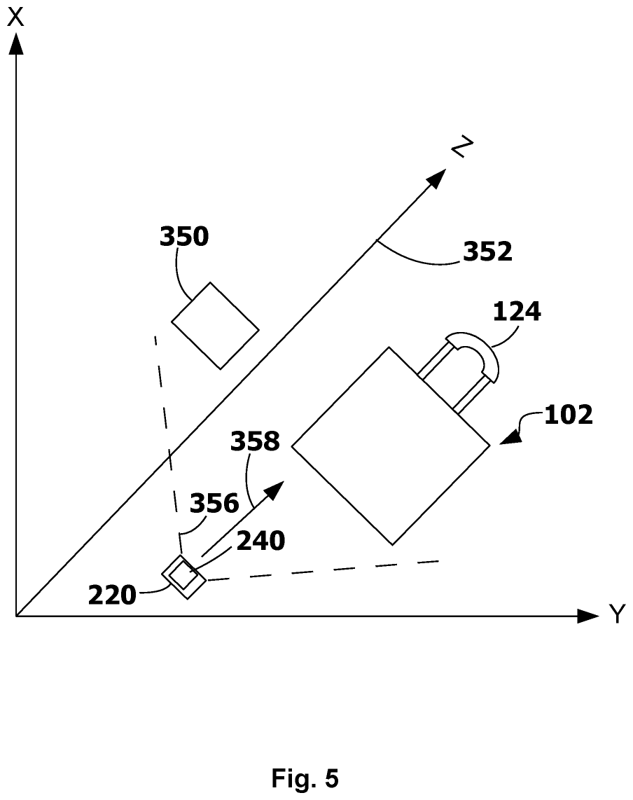

Referring also to FIGS. 4 and 5, user device 220 may further includes one or more cameras 240 communication unit 242 to communicate with the communication network 230 and a user interface 244. In accordance with the present invention there is provided a method and system for measuring objects size such as but not limited to carry-on bags that are allowed to enter to the airplane cabinet. To measure the potential carry-on bag or the measured object 102 there is provided a referenced object 350. The reference object is an object that his size measurement are predetrmine and known by the system 200. The reference object can be a physical object of a three or two damentios. The reference object 350 can be made of any suitable material, such as plastic, a magnet, a sticker, wood metal or any combination thereof. The reference object 350 in some embodiments of the present invention can be a virtual object, for example an object projection projected from a projector (not shown). The reference object 350 can be positioned on the measured object 102 or in a preferred embodiment of the present invention near the measured object aligned side by side as shown for example in FIGS. 4 and 5. The referenced object is also preferably positioned in the area where the languages are being weighed. In FIGS. 4 and 5 there are shown two axes, axis 352 and axis 354. Measured object 102 and reference object are positioned aligned to line 354 which is perpendicular line 352. In FIGS. 4 and 5 also shown schematically the telescopic handle 124 of carry-on bag (the measured object). The dashed lines 356 represents the field of view of the camera 240. Arrow line 358 designates where the camera is pointed to. In FIGS. 4 and 5 illustrated that camera 240 in accordance with the preferred embodiment of the present invention pictures both objects 220 and 102 in the same picture. In the preferred embodiment of the present invention the camera is a built-in camera of a smart device such as but not limited to smartphone or tablet. In accordance with the present invention the application or one or more of modules 202 on user device 220 identifies the referenced object which is utilized for calculating the size of the measured object 102.

One of the benefits of the present invention is that the measurements result in associate with the measured object and the time it is processed the picture taken by camera 240 are more accurate and faster than known in the art augmented reality techniques to measure an unknown size of suitcases and bags because of the use of a physical reference two- or three-dimensional object and its comparison to the size of the measured object in the real world. More detail description about the method to measure measured object in accordance with the present invention will be described later.

Another benefit of the present invention is that the method of the present invention is easier and simpler to the user 250 for knowing the size of the three-dimensional measured object. The user 250 for example don't need to walk and circle around the measured object and take multiple photos in different angles or scan the measured object to know the actual size of the measured object 102.

Yet another benefit of the present invention is that airlines or companies that provide ground services to airlines could make more money at the counter by selling the service that checks if the measured object is small enough if yes, the object can enter to the airplane cabinet.

Yet in another benefit of the present invention each airline company will know how much money the application of the size measurement services is made for the company on flights and one or more data reports about the measurement results, that will be described later in more detail. The reports can be generated for analysis and decision making.

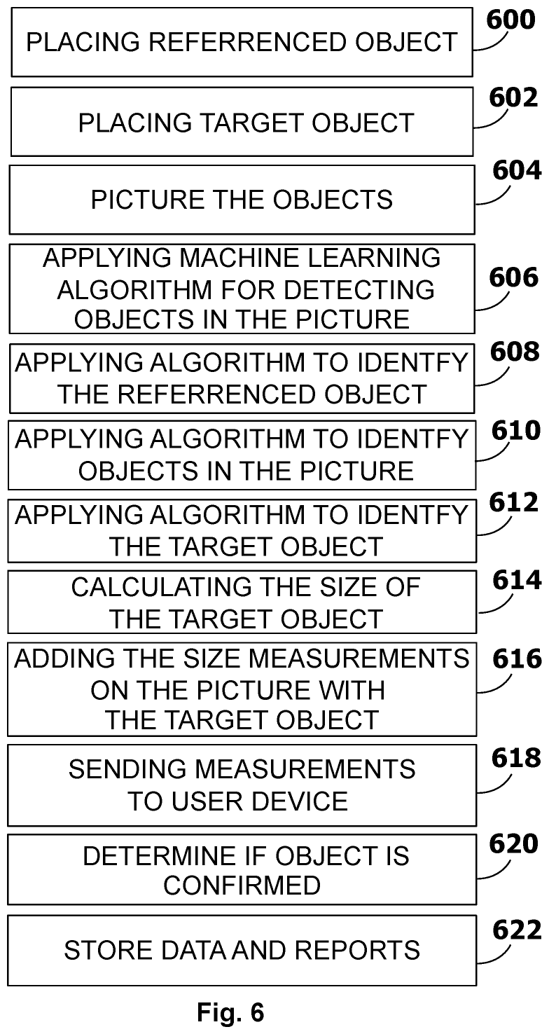

Referring to FIG. 6 there is shown a flow diagram of an exemplary method for measuring objects in accordance with some embodiments of the present invention. In step 600 placing the reference object 350 and the measured object 102 align to one another. Preferably but not limited to, the referenced object 350 can be a two-dimensional Quick Response (QR) code sticker. One of the reasons for using the QR code as a referenced object is that an object detection algorithm can detect the referenced object faster and easier.

In step 602 placing the measured object 102 to be aligned with the reference object 350. In step 604 taking one or more pictures by camera 240 of the two object 350 and 102. In the preferred embodiments of the present invention two camera pictures are needed for each view, for example top and side view. In step 606 applying a machine learning (ML) algorithm for detecting objects in a picture. One example of such algorithm may be Mask R-CNN which is a Convolutional Neural Network (CNN) regarding image segmentation. This variant of a Deep Neural Network detects objects in an image and generates a high-quality segmentation mask for each instance. A Convolutional Neural Network (CNN) is a type of artificial neural network used in image recognition and processing that is optimized to process pixel data. Therefore, Convolutional Neural Networks are the fundamental and basic building blocks for the computer vision task of image segmentation (CNN segmentation). The Convolutional Neural Network Architecture consists of three main layers:
a. Convolutional layer: This layer helps to abstract the input image as a feature map via the use of filters and kernels.
b. Pooling layer: This layer helps to downsample feature maps by summarizing the presence of features in patches of the feature map.
c. Fully connected layer: Fully connected layers connect every neuron in one layer to every neuron in another layer.
   Combining the layers of a CNN enables the designed neural network to learn how to identify and recognize the object of interest in an image. Simple Convolutional Neural Networks are built for image classification and object detection with a single object in the image. In a more complex situation with multiple objects in an image, a simple CNN architecture isn't optimal. For those situations, Mask R-CNN or Faster R-CNN can be used for example.

In step 608 applying another algorithm to identify the referenced object. In step 610 applying another algorithm to identify the objects in picture(s). In step 612 applying another algorithm to identify the measured object. In step 614, calculating the size of the measured object relative to predetermine known size of the referenced object detection. In step 616, isolate or cut editing of the picture(s) to have in the picture the measured object without the referenced object. In addition, adding size measurements layer on the edited picture(s) for example as shown in FIG. 1 and 2. In step 618, connecting one or more database services and sending the measured picture and data results to the user device 220. The applied algorithms mentioned above can be applied in some embodiments of the present invention in database 210 and/or database server 212 and in other embodiments of the present invention the applied algorithms can be applied in the user device 220. In step 620, determine if the measured object is confirmed or not to enter the flight airplane cabinet. In step 622, storing the data and reports about the passenger and the passenger measured objects.

Management interface of airlines companies in accordance with some embodiments of the present invention may include the following options:
1. Entering the allowed carry-on bag measurements for the bags that can be entered to the airplane cabinet.
2. Entering flight schedules, each airline company may have a code for example such that when a device user enters the code, he will see only the flights data of a particular airline company.
3. The system of the present invention in some embodiments of the present invention can interface with the systems of an airline companied for example for sending reports and receiving reports and data. The received data reports could be for example the flight schedule of the airline companies. The sending data reports could for example detail data about the carry-on bags that confirmed and the ones that don't during a predetermine period. The interface between the airline system and system of the invention could be for example by interfacing between database 210 and database 212.

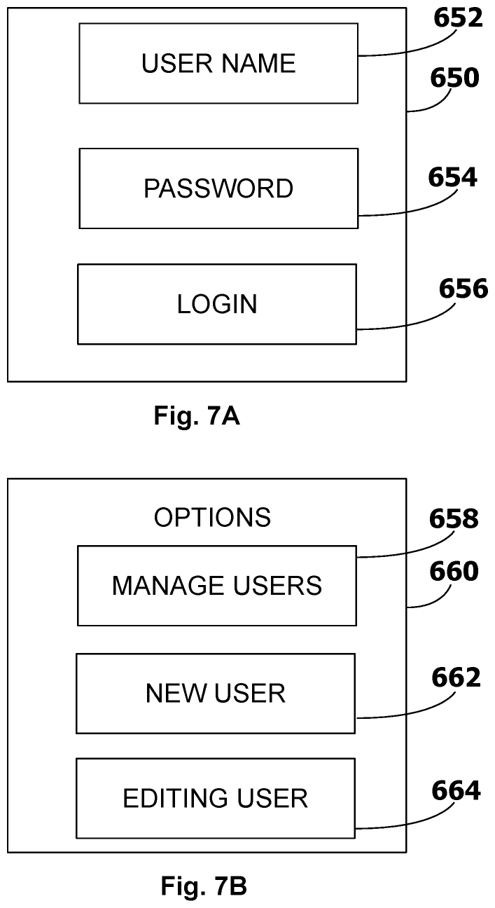

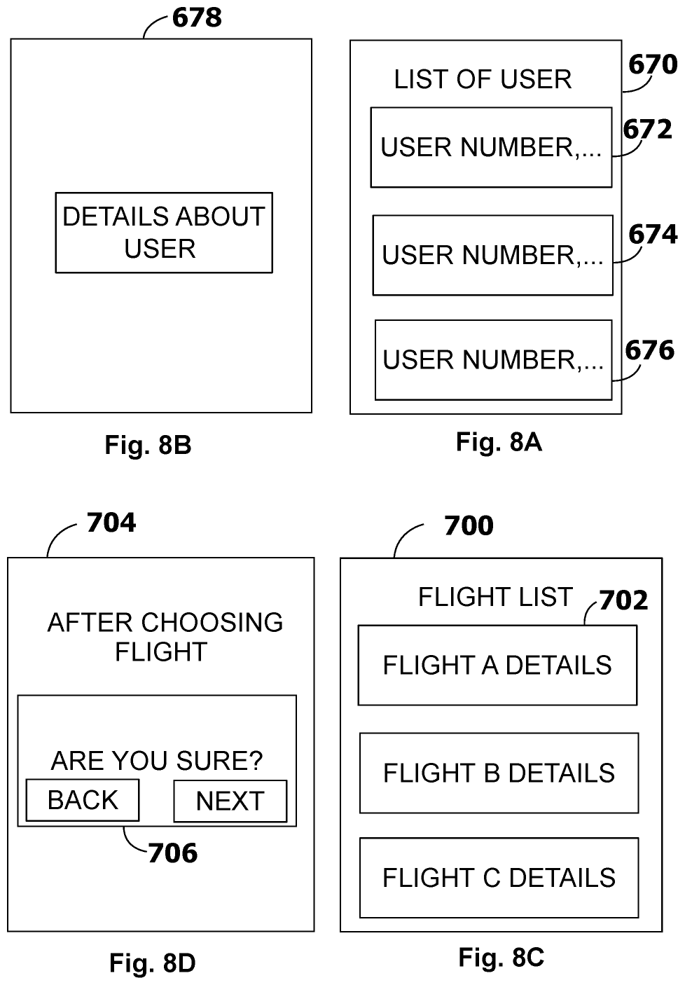

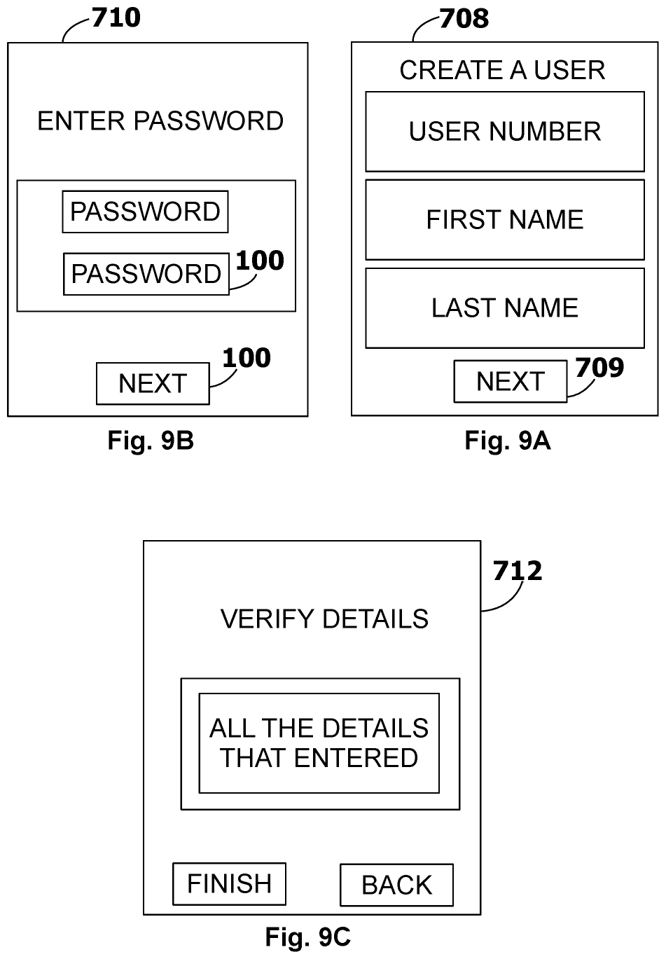

Management interface of the airline's companies' handlers in accordance with some embodiments of the present invention may include the following options:
1. Creating and editing users.
2. Placements of workers (device users 250), which can be optional if for example one handling company is responsible of multiple counters of multiple airlines companies.
   Referring to FIG. 7A-7B the Management interface of the airline's companies' handlers may include a login webpage 650 having username 652, password 654 and login 656 interface units to login to the management option page 660 by an authorized user. Page 660 may include for example “manage user”, “new user”, “editing user” interface options. Referring to FIGS. 8A-8D, when choosing the “manage user” option the authorized user may have a list of workers or users 670 where the authorize user can choose a user interface option from the list of users' interface options for example 672, 674 and 676. When an authorized user chooses a user interface option detail about the chosen user is shown on a web page 678. On a flight list webpage 700 the authorized user can assign flights 702 from the flight list page 700. After choosing flight detail another webpage or alert window is open 704 to confirm the flight assignment to a user 706.

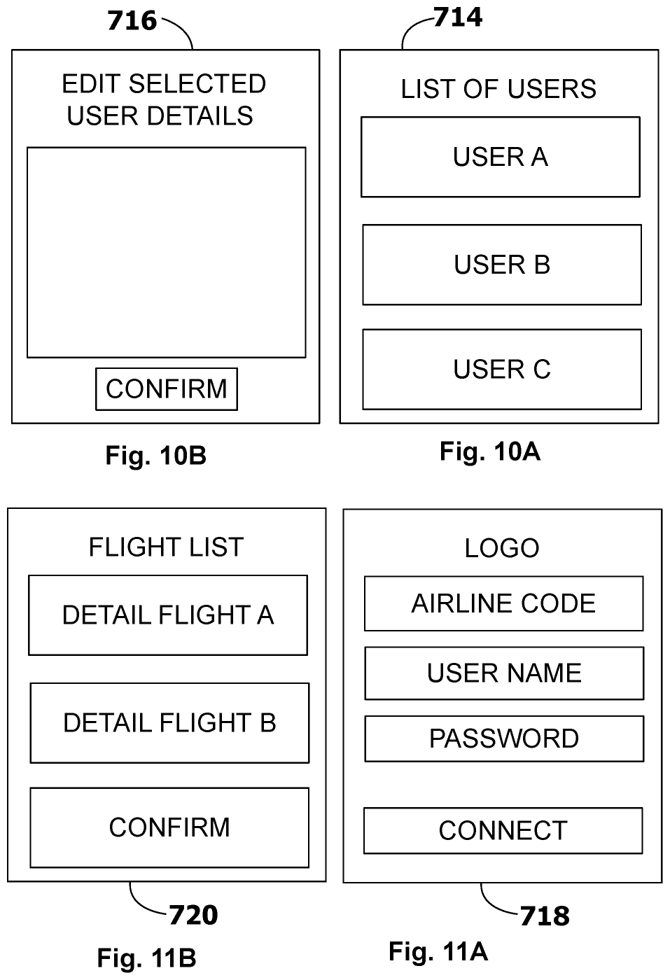

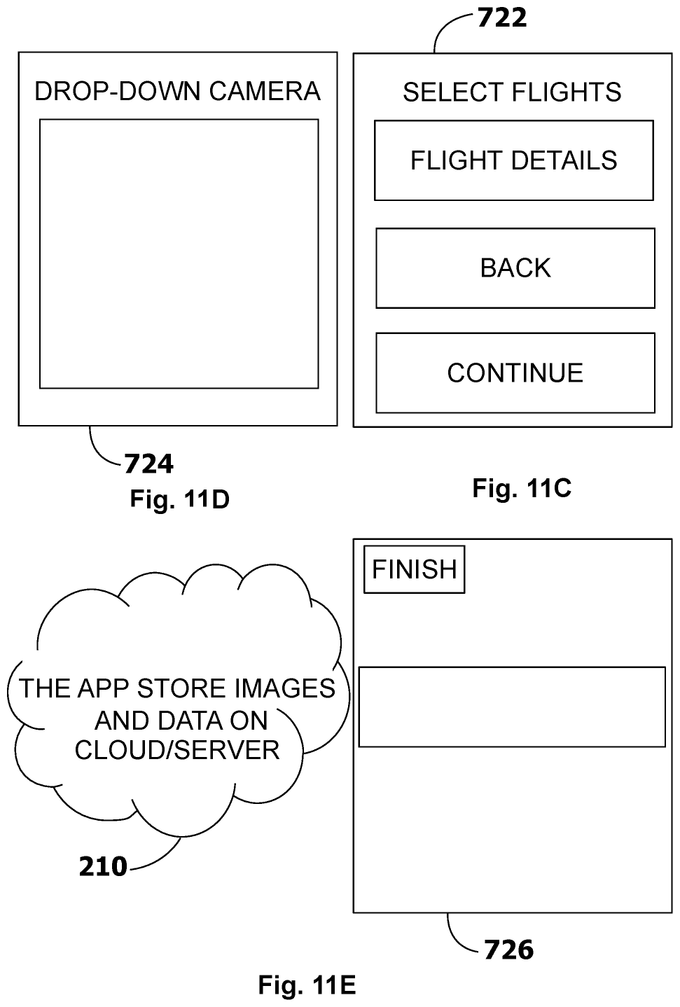

Referring to FIGS. 9A-9C, when choosing the “new user” option an authorized user can create a new user in webpage 708 by entering the details of the new user. After clicking the “next” button 709. Password webpage 710 is opened for creating to the new user a new username and new password. In webpage 712 all the details that were entered by the authorized user is shown for confirmation to the authorized user. Referring to FIGS. 10A-10B when choosing the “editing user” option a list of user webpage 714 is shown and the authorized user can which user data page he wants to update. When the authorized user selects a user data to be updated detail about the user web page 716 is opened and the authorized user can change and edit the selected user data and after finishing, he can press the “confirm” button.

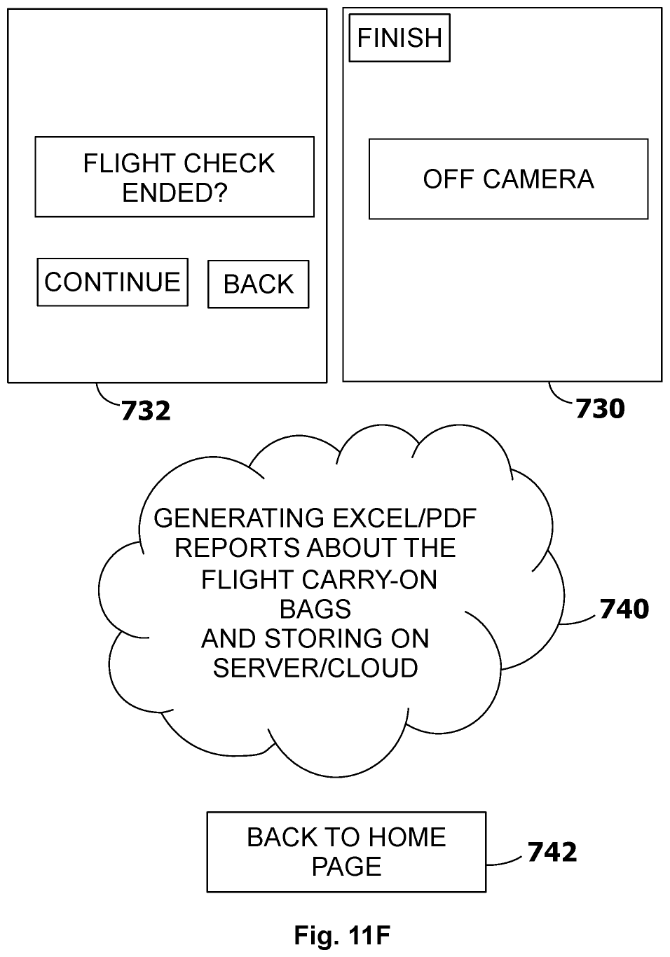

An exemplary work interface web pages of a device user 250 is shown schematically in FIGS. 11A-11F. In FIG. 11A the device user is login 718 to the system of the invention from user interface 244. In FIG. 11B the device user sees his flight list 720 from user interface 244 and he can see the details about each flight. In FIG. 11C the user selects the current flight data 722 where the passengers need to come to the counter in the check-in. In FIG. 11D the camera interface page is opened for taking pictures of a measured object 102 of a passenger with the reference object 350 (referred to also to FIG. 4 for example). Referring to FIG. 11E the pictures data are processed on device 250 or on database server/cloud 210 and afterwards the user can see on page 726 the interface page that is shown in FIG. 2 if the carry-on bag is not approved or the interface page in FIG. 3 if the carry-on bag is approved to be carry-on to the airplane cabinet. The user repeat working on pages in FIGS. 11C to 11E until he finishes with all the passengers of the current flight. In FIG. 11F the device user closes the camera 730 and if the device user approve that the flight bags check is ended 732. Excel/pdf reports about the flight carry-on bags are generated and stored in the databases/clouds 210 and 212.

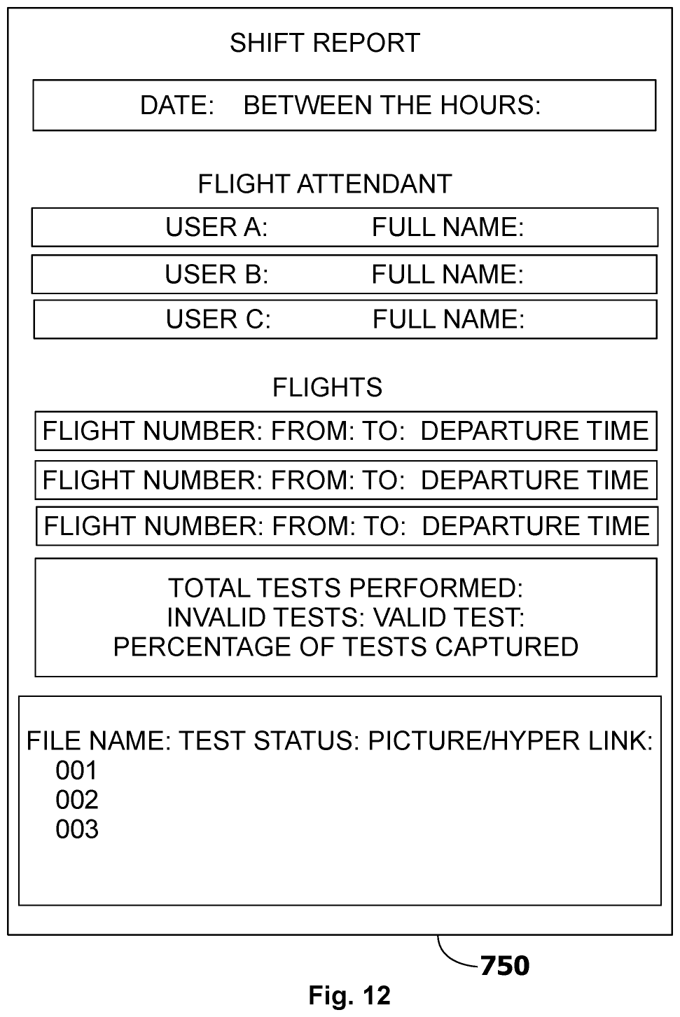

Referring to FIG. 12 there is shown an interface view 750 that illustrates an exemplary interface shift report regarding user devices 250. The shift report may include date of shift and hours shift. The shift report may also include flight attendant users and their name and other relevant data. Flights details are also included in the report. In addition, data about the total bag measurement test of passengers that were executed, the number of valid tests (carry-on bags that are confirmed to enter the airplanes cabinets), number of invalid test (carry-on bags that are not confirmed to enter the airplanes cabinets) and percentage of test captured. The report may further include files or hyperlinks to the interface pages that are shown in FIG. 1 or FIG. 2.

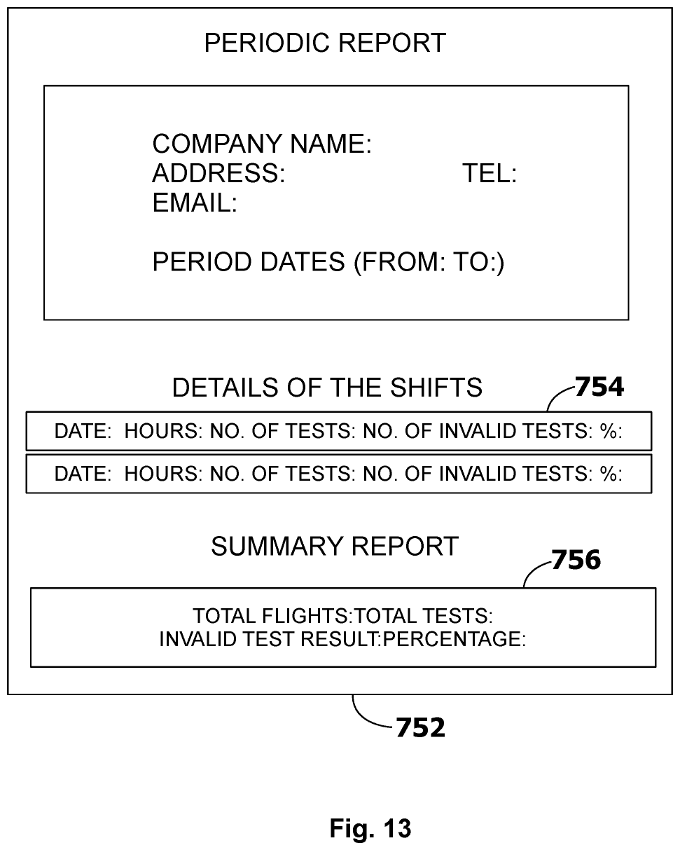

Referring to FIG. 13 there is shown an interface view 752 that illustrates an exemplary periodic report. The report 752 includes the handler company name. details about the user devices' shifts such as date, number of tests, number of valid bag test and non-valid test and percentage of valid test in respect to all the tests. Also, the report includes the total flights, total test, total valid test, and total percentage of valid test in respect to all of the tests.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A system for object measurement comprising:
at least one user device having: at least one camera, at least one module performing one or more tasks, at least one memory unit for storing, loading, and/or maintain said at least one modules; said user device further having at least one processor interpreting and/or executing computer-readable instructions; in said processor access and/or modify and execute said at least one module stored in said memory; at least one communication unit to communicate with at least one communication network and a user interface;
said system further comprising, at least one reference object with predetermine known size;
wherein, said at least one camera take picture of said at least one reference object and said at least one measurement object;
whereby,
at least one of said modules used for identifying said referenced object in said at least one picture; at least one of said modules used for identifying said measurement object in said at least one picture; at least one of said modules used for calculating the size of said at least one measured object, utilizing the predetermine known size of said referenced object detection.

2. A system according to claim 1, wherein said at least one module applying a Mask R-CNN machine learning algorithm for identifying objects in said pictures taken by said camera.

3. A system according to claim 1, wherein said system further comprising at least one sever for storing information associated with passengers' carry-on bags measurement approval and not approval data and the passenger flights data.

4. A system according to claim 3, wherein said at least one server is selected from a group of application servers, storage servers, database servers, web servers, cloud servers, and/or any other suitable computing device configured to run certain software applications and/or provide various application, storage, and/or database services.

5. A system according to claim 1, wherein said at least one reference object is a two-dimensional object.

6. A system according to claim 1, wherein said at least one reference object is a three-dimensional object.

7. A system according to claim 1, wherein said at least one reference object is a QR code.

8. A system according to claim 1, wherein said measured object is a carry-on bag that are allowed to enter an airplane.

9. A system according to claim 1 wherein, the reference object positioned on the measured object or near the measured object aligned side by side.

10. A system according to claim 1, wherein said user device is a smart device having a built-in camera.

11. A system according to claim 1, wherein said user device is selected from a group of servers, desktops, laptops, tablets, cellular phones, (e.g., smartphones), personal digital assistants (PDAs), multimedia players, embedded systems, wearable devices (e.g., smart watches, smart glasses, etc.), gaming consoles, combinations of one or more of the same, or any other suitable mobile computing device.

12. A system according with claim 1 wherein, said user that uses said system is selected from a group of airlines admin worker, manager/worker of ground airport handling agents, airline-employed staff at check-in counters at airports or through an agency arrangement or by way of a self-service kiosk, airlines subcontract ground handling to airports, handling agents or even to another airline.

13. A system according with claim 1 wherein said system further comprising at least one database and at least one application connected to said database detecting objects in said at least one picture; to identify the reference object and the measurement object and to calculating the size of the measurement object by utilizing the reference object.

14. A method for object measurement having at least one user device with at least one camera, said at least one user device communicating over a communication network and at least one database communicating with said user device over said communication network comprising the steps of:
placing at least one object reference and object measurement aligned to one another;
taking at least one picture of said at least one object measurement and said at least one reference object by said user device camera;
applying a machine learning (ML) algorithm for detecting objects in said at least one picture;
applying an algorithm to identify said referenced object in said at least one picture;
applying algorithm to identify said measured object in said at least one picture;
calculating the size of said measured object relative to predetermine known size of said at least one referenced object detection;
wherein if said size of said at least one measured object is bigger then the size of a predetermine object size said at least one measured object is not confirmed, otherwise said at least one measured object is confirmed.

15. A method for object measurement according to claim 14 wherein, said object reference is a two-dimensional Quick Response (QR) code.

16. A method for object measurement according to claim 14 wherein, at least two camera pictures are taken by said camera to picture said reference object and said measurement object, one picture for top view and the other picture for side view.

17. A method for object measurement according to claim 14 wherein, said machine learning (ML) algorithm for detecting objects in said at least one picture is a Mask R-CNN algorithm.

18. A method for object measurement according to claim 14 wherein, said method further comprising the step of isolating or cut editing of said at least one picture to have in a picture, said measured object without said referenced object.

19. A method for object measurement according to claim 18 wherein, said method further comprising the step of adding size measurements layer on said edited picture.

20. A method for object measurement according to claim 14 wherein, said method further comprising the step of connecting to at least one database services and sending said measured picture and said results measurements to said user device.

21. A method for object measurement according to claim 14 wherein, said measurement object is a potential carry-on bag and said method determines if said potential carry-on bag is confirmed or not to enter to a flight airplane cabinet.

22. A method for object measurement according to claim 21 further comprising the step of storing said measurement results data and report about a passenger and said passenger potential carry-on bag.

23. A method for object measurement according to claim 21 further comprising the step of managing interface of airlines companies.

24. A method for object measurement according to claim 21 further comprising the step of managing interface airline's companies' handlers.
